(19) United States
(12) Patent Application Publication
(10) Pub. No.: US 2021/0195990 A1
(43) Pub. Date: Jul. 1, 2021

(54) THERMAL RETENTION LAYER FOR FOOTWEAR

(71) Applicant: Robert Burnett, Merrill, WI (US)

(72) Inventor: Robert Burnett, Merrill, WI (US)

(73) Assignee: Weinbrenner Shoe Company, Inc., Merrill, WI (US)

(21) Appl. No.: 16/731,476

(22) Filed: Dec. 31, 2019

(51) Int. Cl. A43B 13/04; B29D 35/12; A43B 13/12

(52) U.S. Cl. CPC A43B 13/04; A43B 13/12; B29D 35/122

(57) ABSTRACT

A footwear item that includes a rubber sole, and an upper portion attached to the rubber sole. The upper portion is made from rubber. The rubber sole includes a layer of aerogel thermal retention material for an interior section of the footwear item. The layer of aerogel thermal retention material covers the interior portion of the rubber sole along with a front part of the footwear item such that the layer of aerogel thermal retention material contacts a sole of a foot of a wearer while also surrounding the toes of the wearer. In certain embodiments, the layer of aerogel thermal retention material has a thickness ranging from 0.1 millimeters to 20 millimeters.

### FIELD OF THE INVENTION

This invention generally relates to a thermal retention layer for use in footwear.

### BACKGROUND OF THE INVENTION

Cold temperatures are often most acutely felt in the extremities, particularly the feet. The susceptibility of our extremities to extreme temperatures may be a serious deterrent to performing certain activities in cold temperatures. Over the years, there have been various techniques used to deal with this problem. For example, conventional designs for footwear, to be used in cold weather, have utilized hard or heavy somewhat insulating materials for the sole and sometimes for the uppers as well. Conventional footwear of this type may include thick or may be accompanied by the use of overboots. In addition to being expensive, such footwear also tends to be heavy and bulky making transport and storage of the footwear somewhat difficult.

Conventional cold-weather footwear often incorporates traditional insulating materials, such as goose down, stiff insulating foam or synthetic fibers, to reduce the loss of heat from the wearer's foot. While these insulating materials attempt to minimize the heat loss from the wearer's foot, they suffer from the shortcomings (i.e., expensive, bulky, heavy) identified above.

Embodiments of the invention address several of the aforementioned problems associated with conventional cold-weather footwear. These and other advantages of the invention, as well as additional inventive features, will be apparent from the description of the invention provided herein.

### BRIEF SUMMARY OF THE INVENTION

In one aspect, embodiments of the invention provide a footwear item that includes a rubber sole, and an upper portion attached to the rubber sole. The upper portion is made from rubber. The rubber sole includes a layer of aerogel thermal retention material for an interior section of the footwear item. The layer of aerogel thermal retention material covers the interior portion of the rubber sole along with a front part of the footwear item such that the layer of thermal retention material contacts a sole of a foot of a wearer while also surrounding the toes of the wearer. In certain embodiments, the layer of aerogel thermal retention material has a thickness ranging from 0.1 millimeters to 20 millimeters.

In a particular embodiment, the rubber sole has a removable footbed which is disposed on top of the layer of aerogel thermal retention material. In certain embodiments, a front part of the rubber sole includes a toe cap that extends up and over the front part of the footwear item so as to protect the toes of the wearer. In other embodiments, a rear part of the rubber sole includes a heel counter that extends upward along a rear section of the footwear item so as to protect the heel of the wearer.

In a further embodiment, the upper portion is made from vulcanized rubber and neoprene rubber. Furthermore, the upper portion may include an attached layer lining the interior of the footwear item. In another embodiment, the upper portion includes a layer of thermal insulation between the attached layer and the upper portion. Moreover, the attached layer may be made from nylon.

In another aspect, embodiments of the invention provide a method of manufacturing a footwear item. The method includes molding a rubber sole, and attaching an upper portion to the molded rubber sole. The upper portion is made from rubber. The method also calls for attaching a layer of aerogel thermal retention material to the rubber sole in an interior section of the footwear item. The layer of aerogel thermal retention material covers an interior portion of the rubber sole along with a front part of the footwear item such that the layer of aerogel thermal retention contacts a sole of a foot of a wearer while also surrounding the toes of the wearer.

In a particular embodiment, the method also calls for assembling a removable footbed to the rubber sole on top of the layer of aerogel thermal retention material. In other embodiments, the method includes lining an interior part of the upper portion with an attached layer. More particular embodiments call for lining an interior part of the upper portion with an attached layer made of nylon. Certain embodiment of the method include providing a layer of thermal insulation between the attached layer and the upper portion.

Attaching the layer of aerogel thermal retention material to the rubber sole may include attaching a layer of aerogel thermal retention material having a thickness ranging from 0.1 millimeters to 20 millimeters. Furthermore, attaching the upper portion to the molded rubber sole may call for attaching an upper portion made from vulcanized rubber and neoprene rubber. Embodiments of the method also include molding a toe cap that extends from the rubber sole up and over the front part of the footwear item so as to protect the toes of the wearer. Other embodiments call for molding a heel counter that extends from the rubber sole upward along a rear section of the footwear item so as to protect the heel of the wearer.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of a footwear item, constructed in accordance with an embodiment of the invention;

FIG. 2 is a partial cross-section of the footwear item of FIG. 1;

FIG. 3 is a top view of the footwear item of FIG. 1;

FIG. 4 is a fully cross-sectional view of the footwear item of FIG. 1;

FIG. 5 is a perspective view of an aerogel thermal retention layer incorporated into the footwear item of FIG. 1, according to an embodiment of the invention;

FIG. 6 is another perspective view of the aerogel thermal retention layer of FIG. 5; and

FIG. 7 is a cross-sectional view of the aerogel thermal retention layer of FIG. 5.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

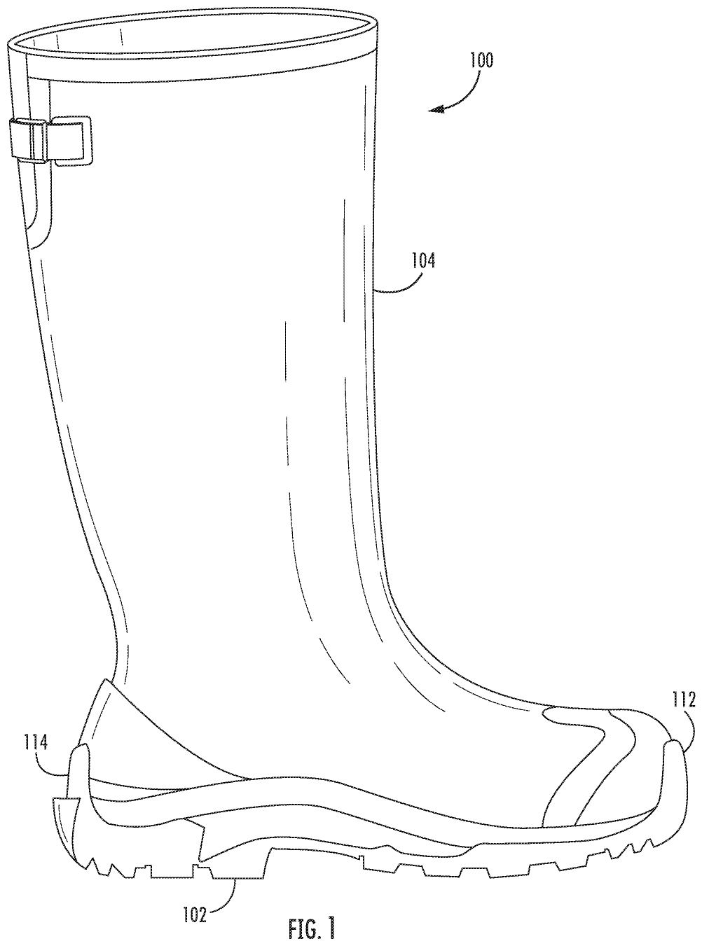

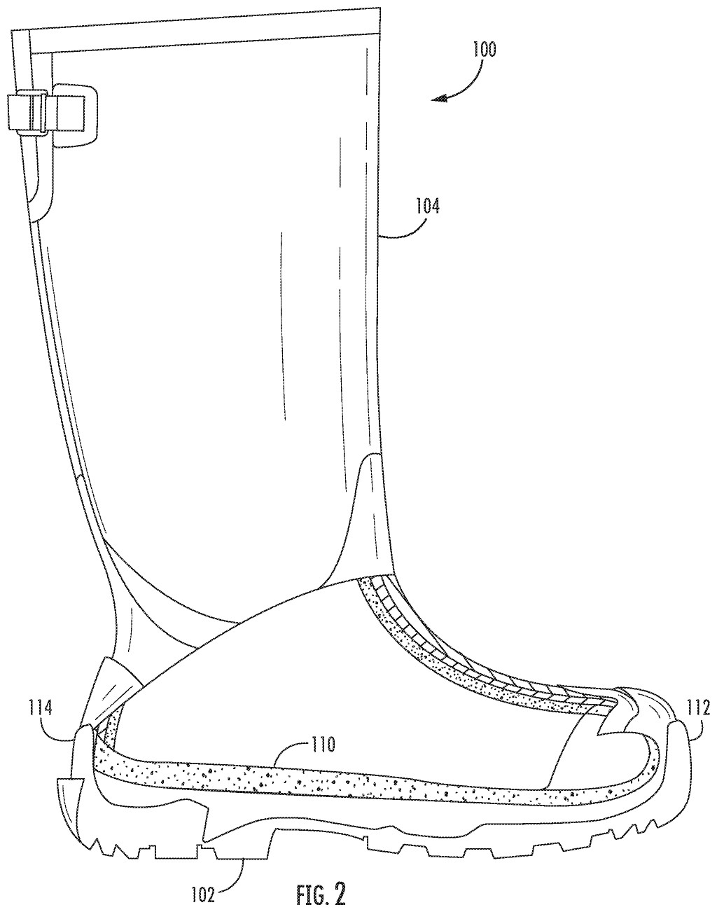

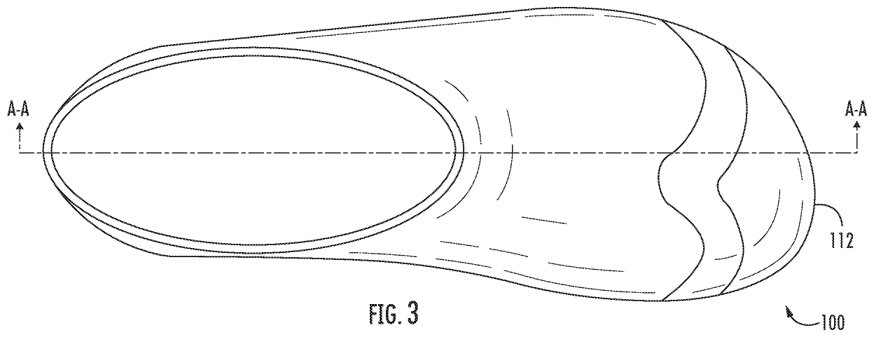

An embodiment of the present invention is illustrated in FIGS. 1-4 as a series of plan, perspective, and cross-sectional views of a footwear item 100, constructed in accordance with an embodiment of the invention. As will be explained below, the footwear item 100 of the present invention includes a thermal retention layer 110 to provide a wearer increased protection against the cold.

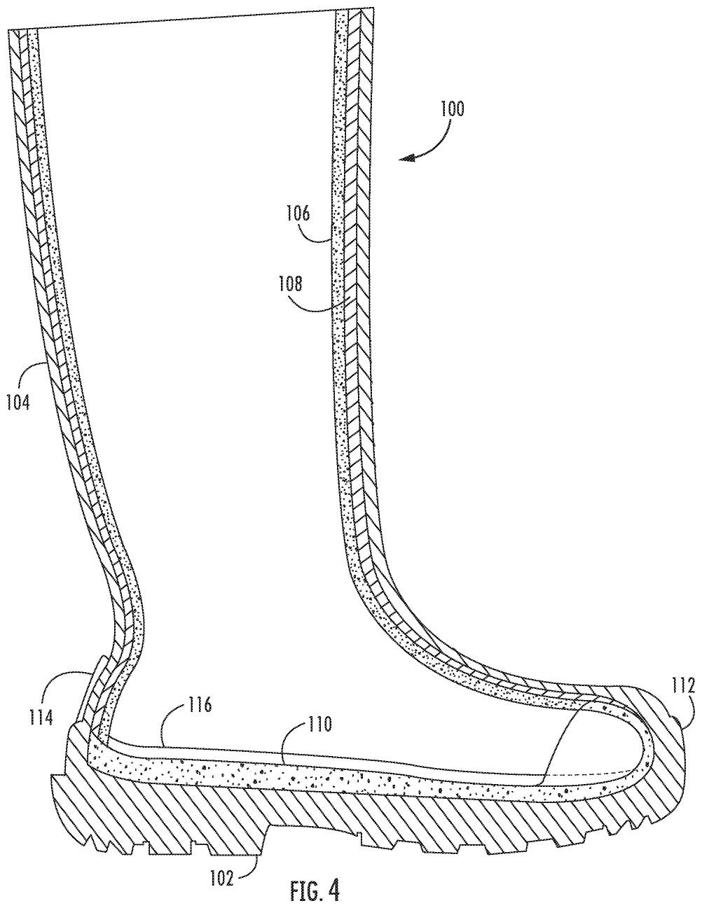

The footwear item 100 has a rubber sole 102 attached to an upper 104 that is also made from rubber. In particular embodiments, the upper 104 is made from a combination of vulcanized rubber and neoprene rubber. In the embodiment of FIG. 4, the interior of the upper 104 includes an attached layer 106 lining the interior of the footwear item 100. This attached layer 106 may be a breathable air mesh lining. In certain embodiments, the attached layer 106 is made from nylon. As can also be seen in the embodiment of FIG. 4, there is a layer of thermal insulation 108 sandwiched between the attached layer 106 and the upper 104. In some embodiments, the thermal insulation 108 is a synthetic insulating material with insulating properties superior to that of most natural materials.

Still referring to FIG. 4, the rubber sole 102 has the thermal retention layer 110 disposed on the interior part of the rubber sole 102. The thermal retention layer 110 may be made from an aerogel material. Aerogels are synthetic, porous, ultralight materials derived from a gel, in which the liquid component for the gel has been replaced with a gas. Aerogels have a porous solid network that contains air pockets, with the air pockets taking up the majority of space within the material. Typically, aerogels are about 99.8% air. The result is a solid with extremely low density and extremely low thermal conductivity. Aerogels can be made from a variety of chemical compounds.

Despite the name, aerogels are solid, rigid, and dry materials that do not resemble a gel in their physical properties. While aerogels tend to be somewhat friable, they also tend to be very strong structurally. Their unusually high load-bearing abilities are due to their dendritic microstructure, in which spherical particles, with an average size of 2-5 nanometers are fused together into clusters. Due to being composed of mostly air, aerogels are good thermal insulators because air is a poor conductor of heat. Furthermore, because their microstructure prevents net gas movement, aerogels do not transfer heat by convection.

In the embodiment shown, the thermal retention layer 110 is designed to cover substantially the entire interior part of the rubber sole 102 so that the thermal retention layer 110 is in contact with the entire sole of the wearer's foot. In a particular embodiment, the thermal retention layer 110 is a layer of aerogel material with a thickness ranging from 0.1 millimeters to 20 millimeters.

In the embodiment shown, the front section of the rubber sole 102 has a toe cap 112 in which the rubber extends up, over, and around the front of the footwear item 100 so as to protect the toes of the wearer. In a further embodiment, the rear section of the rubber sole 102 has a heel counter 114 that extends up along the rear part of the footwear item 100 so as to protect the heel of the wearer.

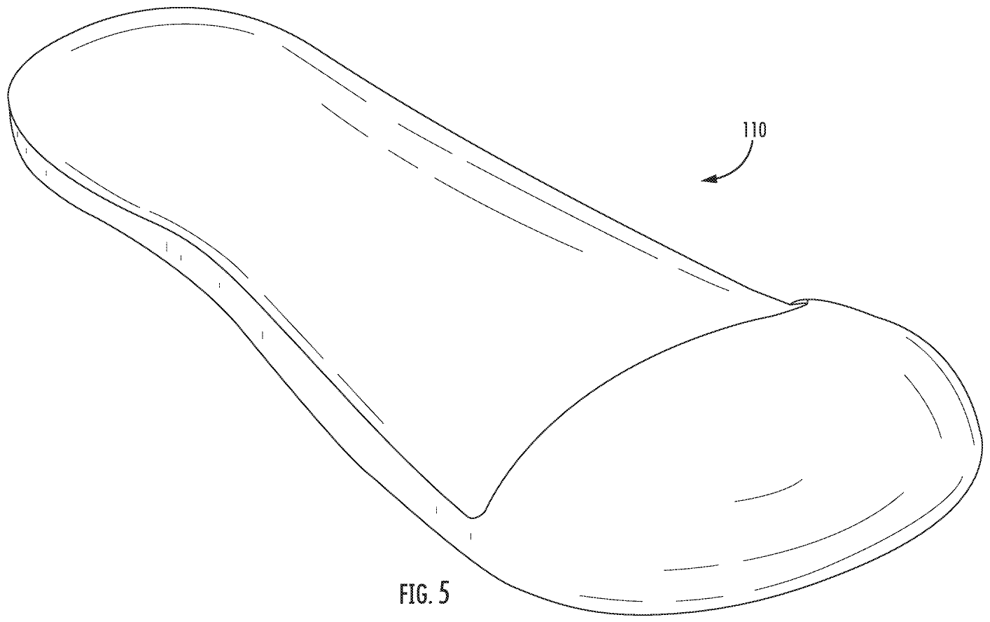

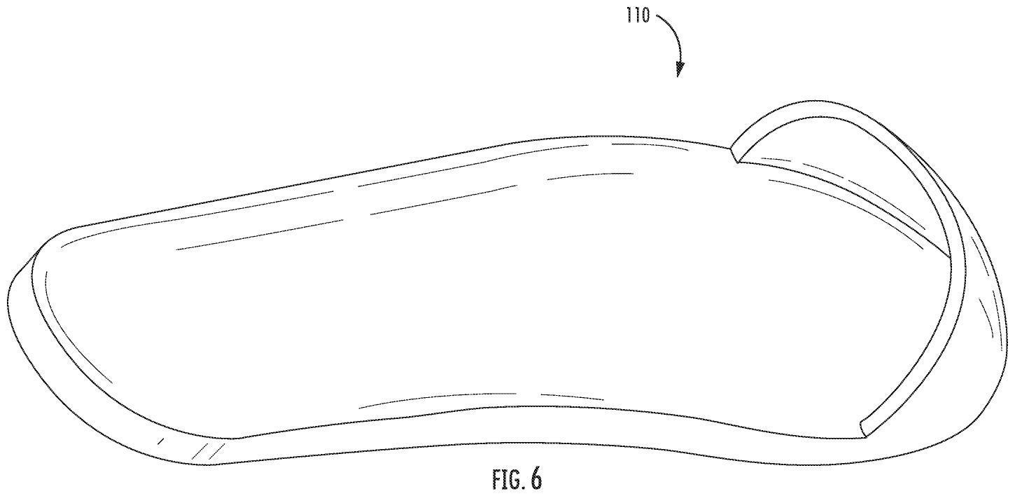

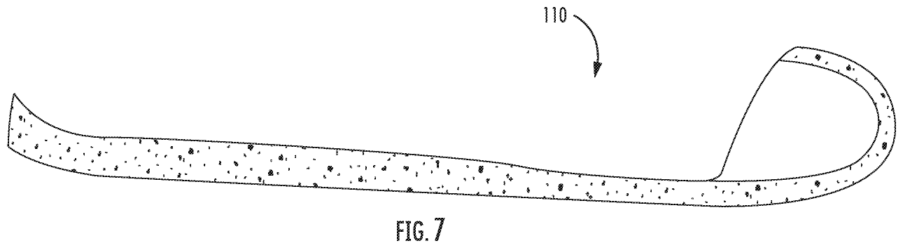

FIGS. 5-7 provide various perspective and cross-sectional views of the thermal retention layer 110. At the front of the thermal retention layer 110, the material extends up and around to cover the toes of a wearer. As used in this application, “front” refers to the part of the footwear item 100 that protects the toes of the wearer, and “rear” refers to the part of the footwear item 100 that protects the heel of the wearer. When fabricated as shown in FIGS. 5-7 the thermal retention layer 110 can be installed much like at insert into the footwear item 100 after its manufacture.

Referring again to FIG. 4, embodiments of the footwear item 100 include a removable footbed 116 which is disposed on top of the thermal retention layer 110. Like the thermal retention layer 110, the removable footbed 116 may be designed as an insert to be installed after manufacture of the footwear item 100.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A footwear item comprising:
a rubber sole;
an upper portion attached to the rubber sole, the upper portion made from rubber;
wherein the rubber sole includes a layer of aerogel thermal retention material for an interior section of the footwear item, the layer of aerogel thermal retention material covering an interior portion of the rubber sole along with a front part of the footwear item such that the layer of aerogel thermal retention material contacts a sole of a foot of a wearer while also surrounding the toes of the wearer.

2. The footwear item of claim 1, wherein the rubber sole has a removable footbed which is disposed on top of the layer of aerogel thermal retention material.

3. The footwear item of claim 1, wherein a front part of the rubber sole includes a toe cap that extends up and over the front part of the footwear item so as to protect the toes of the wearer.

4. The footwear item of claim 1, wherein a rear part of the rubber sole includes a heel counter that extends upward along a rear section of the footwear item so as to protect the heel of the wearer.

5. The footwear item of claim 1, wherein the upper portion is made from vulcanized rubber and neoprene rubber.

6. The footwear item of claim 1, wherein the upper portion includes an attached layer lining the interior of the footwear item.

7. The footwear item of claim 6, wherein the upper portion includes a layer of thermal insulation between the attached layer and the upper portion.

8. The footwear item of claim 6, wherein the attached layer is made from nylon.

9. The footwear item of claim 1, wherein a thickness of the layer of aerogel thermal retention material is from 0.1 millimeters to 20 millimeters.

10. A method of manufacturing a footwear item comprising the steps of:
molding a rubber sole;
attaching an upper portion to the molded rubber sole, the upper portion made from rubber;
attaching a layer of aerogel thermal retention material to the rubber sole in an interior section of the footwear item, the layer of aerogel thermal retention material covering an interior portion of the rubber sole along with a front part of the footwear item such that the layer of aerogel thermal retention material contacts a sole of a foot of a wearer while also surrounding the toes of the wearer.

11. The method of claim 10, further comprising assembling a removable footbed to the rubber sole on top of the layer of aerogel thermal retention material.

12. The method of claim 10, further comprising lining an interior part of the upper portion with an attached layer.

13. The method of claim 12, wherein lining the interior part of the upper portion with an attached layer comprises lining an interior part of the upper portion with an attached layer made of nylon.

14. The method of claim 12, further comprising providing a layer of thermal insulation between the attached layer and the upper portion.

15. The method of claim 10, wherein attaching the layer of aerogel thermal retention material to the rubber sole comprises attaching a layer of aerogel thermal retention material having a thickness ranging from 0.1 millimeters to 20 millimeters.

16. The method of claim 10, wherein attaching the upper portion to the molded rubber sole comprises attaching an upper portion made from vulcanized rubber and neoprene rubber.

17. The method of claim 10, wherein molding the rubber sole comprises molding a toe cap that extends from the rubber sole up and over the front part of the footwear item so as to protect the toes of the wearer.

18. The method of claim 10, wherein molding the rubber sole comprises molding a heel counter that extends from the rubber sole upward along a rear section of the footwear item so as to protect the heel of the wearer.
